(19) United States
(12) Patent Application Publication
(10) Pub. No.: US 2025/0315340 A1
(43) Pub. Date: Oct. 9, 2025

(54) DEFINING RECOVERY PERFORMANCE GOALS FOR APPLICATIONS

(71) Applicant: INTERNATIONAL BUSINESS MACHINES CORPORATION, ARMONK, NY (US)

(72) Inventors: Matthew Paul Wilson, Easteligh (GB); Sandra Gashi, Eastleigh (GB); Christopher Neil Bailey, Romsey (GB); IAN PARTRIDGE, Eastleigh (GB); David Richard Jones, Eastleigh (GB)

(21) Appl. No.: 18/648,555

(22) Filed: Apr. 29, 2024

(30) Foreign Application Priority Data
Apr. 3, 2024 (GB) 2404731.8

(51) Int. Cl. G06F 11/07; G06F 11/34

(52) U.S. Cl. CPC G06F 11/0793; G06F 11/3409

(57) ABSTRACT

A method, computer program product, and computer system for defining a recovery performance goal for an application. The method includes obtaining data of errors experienced by users of the application when carrying out an operation in a task; obtaining data of outcomes of the task; correlating requests and responses from the error data with an outcome of the task; determining an error duration from the requests and responses of the error data; aggregating the error duration and outcome per backend service of the application for multiple users; evaluating a recovery period based on a proportion of successful outcomes compared to an error duration for the service; and defining a recovery performance goal based on the evaluation.

### BACKGROUND

The present invention relates to application performance due to errors, and more specifically, to defining recovery performance goals for applications.

Applications often define recovery performance goals such as a Mean Time to Recovery (MTTR) goal. This is a performance goal for an amount of time to recover from a failure in a system. Such goals have the purpose of providing a metric for support and maintenance teams to ensure repairs or error handling is efficient.

### SUMMARY

According to an aspect of the present invention, there is provided a computer-implemented method for defining a recovery performance goal for an application, the method comprising: obtaining data of errors experienced by users of the application when carrying out an operation in a task; obtaining data of outcomes of the task; correlating requests and responses from the error data with an outcome of the task; determining an error duration from the requests and responses of the error data; aggregating the error duration and outcome per backend service of the application for multiple users; evaluating a recovery period based on a proportion of successful outcomes compared to an error duration for the service; and defining a recovery performance goal based on the evaluation.

### BRIEF DESCRIPTION OF THE DRAWINGS

Embodiments of the present invention will now be described, by way of example only, with reference to the accompanying drawings:

FIG. 1 is a flow diagram of an example of a method in accordance with embodiments of the present invention.

FIGS. 2A and 2B are example graphs showing outcomes of the method of FIG. 1.

FIG. 3 is a block diagram of an example of a system in which the described system may be implemented.

FIG. 4 is a block diagram of an example of a system in accordance with embodiments of the present invention.

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for defining a recovery performance goal for services of an application. The method may take as input data of errors experienced by users as obtained from a client-side or a server-side for an application. The method may process the error data and evaluate a successful outcome of a user task (for example, a user session or a user action) compared to an error duration for a service of the application. The processing and evaluation may be used to define a recovery performance goal for the service of an application. A recovery performance goal may be an MTTR goal or other form of target for tracked recovery metrics. The MTTR may form part of a wider Service-Level Objective (SLO) goal. Using the described method, the recovery goal is based on user-centric data and resultant outcomes.

The method has the advantage of providing an outcome-based recovery goal that takes into account the error duration of a service of an application.

According to another aspect of the present invention, there is provided a system for defining a recovery performance goal for an application, comprising: a processor and a memory configured to provide computer program instructions to the processor to execute a method of: obtaining data of errors experienced by users of the application when carrying out an operation in a task; obtaining data of outcomes of the task; correlating requests and responses from the error data with an outcome of the task; determining an error duration from the requests and responses of the error data; aggregating the error duration and outcome per backend service of the application for multiple users; evaluating a recovery period based on a proportion of successful outcomes compared to an error duration for the service; and defining a recovery performance goal based on the evaluation.

According to a further aspect of the present invention, there is provided computer program product for defining a recovery performance goal for an application, the computer program product comprising a computer-readable storage medium having program instructions embodied therewith, the program instructions executable by a processor to cause the processor to: obtain data of errors experienced by users of the application when carrying out an operation in a task; obtain data of outcomes of the task; correlate requests and responses from the error data with an outcome of the task; determine an error duration from the requests and responses of the error data; aggregate the error duration and outcome per backend service of the application for multiple users; evaluate a recovery period based on a proportion of successful outcomes compared to an error duration for the service; and define a recovery performance goal based on the evaluation.

The computer-readable storage medium may be a non-transitory computer-readable storage medium, and the computer-readable program code may be executable by a processing circuit.

As previously stated, applications often define recovery performance goals such as a Mean Time to Recovery (MTTR) goal. This is a performance goal for an amount of time to recover from a failure in a system. Such goals have the purpose of providing a metric for support and maintenance teams to ensure repairs or error handling is efficient. Such recovery performance goals are conventionally arbitrary values that do not take into account the impact and downstream effects of downtime of an application service due to an error and recovery time. In a distributed system with multiple backend components, the impact of a failure on a user's experience may vary significantly. For example, if a company logo fails to load on a webpage this will likely have minimal impact on user outcomes, whereas an error experienced when clicking a ‘Buy’ button will likely have a much more significant impact.

In one example, the application may be hosted on a backend server with user clients. The clients may use a browser, local front end, or web server to access the application. As an example, an application may be a transaction-based application and a successful outcome may be a successfully completed transaction. In another example, the application may be a search application and the successful outcome may be a return of search results.

The duration over which a user experiences a failure may impact outcomes of the user application interaction. If the user tries clicking the ‘Buy’ button again and it succeeds, this has not impacted the outcome. However, if the failure persists over longer durations, the user is more likely to abandon the action, and therefore impact the desired outcome. The acceptable error duration can vary widely depending on the type of application, from short durations for digital experience, to longer durations for business tools like email or business process applications.

The described method determines a performance goal for an application based on the analysis of errors encountered during user interactions, and by evaluating the impact of specific durations of errors or outages and deriving optimized goals for different services within the application. The method allows an application owner to derive meaningful MTTR goals for their application components, in order to optimize real outcomes of the system. The method can determine the impact of errors on the outcome, which may vary for each component or service, and therefore set an appropriate MTTR goal based on this impact.

The method describes how errors experienced by the user of an application, and the user's resulting behavior, can be measured and correlated with the availability of corresponding backend services, providing insight into the impact of specific types and durations of errors or outages.

The definition of recovery performance goals is an improvement in the technical field of computer performance generally and more particularly in the technical field of improving and optimizing response to errors in application services.

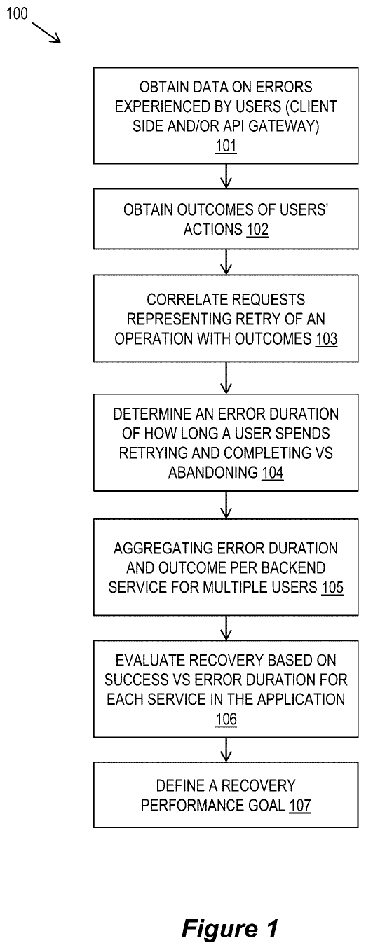

Referring to FIG. 1, a flow diagram 100 shows an example embodiment of the described method for defining a recovery performance goal for an application or a service in the application.

The method obtains 101 data on errors experienced by users of the application when carrying out an operation in a task. The data may be obtained on the client-side, on the server-side at the application gateway, or both. The client-side data may be obtained by capturing errors experienced by a user, such as failed requests, application, or script errors. Server-side application error monitoring may capture errors at the application gateway, such as error responses and timeouts.

The method may obtain 102 outcomes of the task including retry attempts of operations encountering errors in the task. The outcomes may be obtained from individual user's actions in order to capture data on successful outcomes of the user's activities and/or failed outcomes of the user's activities. For example, whether the user tried again and completed their intended task or whether they gave up. A successful outcome may be identified by a presence of subsequent requests in a same user session indicating a continuance of a user's journey. For example, a user continuing to add an item to a basket following a successful search operation.

Outcomes may be measured by monitoring outcomes at the server-side by obtaining measurements of time taken for successful completion of the task or abandonment of the task where an error is encountered. This may use analytics tools such as web and/or application analytic tools. Where a task is a transaction, the outcome may be the completion or abandonment of the transaction.

Outcomes may also or alternatively be measured by user analytics at the client-side used to measure user satisfaction and feedback, with user satisfaction indicating a successful outcome. The user analytics may analyze at least one of: the presence (or not) of a subsequent user interaction with the application; a user input response to a request for satisfaction information; survey data provided by the user; one or more complaints provided by the user; and a time taken to complete a transaction of the application. The exact nature of this metric will be determined by the application. For example, in many applications, one can determine satisfaction from whether a user completes or abandons a transaction. If a user is dissatisfied with the performance of a search results page, they will never continue to purchase a product. Alternative methods could also be used, such as user surveys. Existing analytics tools can also be used to measure satisfaction.

The method may correlate 103 requests and responses from the error data representing retries of an operation relating to a task with an outcome of the task. The requests may represent a user or component retrying an operation with resulting outcomes.

The correlation 103 identifies whether the desired outcome was achieved for the task or session. This may be inferred directly from a successful request or may require identifying a request made further along the user's digital journey. For example, in a checkout process, the business outcome is the user making a successful payment. If an error occurs in the stock check service but a subsequent request succeeds, the user may still become frustrated and abandon the checkout process before making a payment. Therefore, the correlator must determine if a payment was successfully completed for a business outcome in order to mark that business outcome as a success.

The method may determine 104 an error duration as how long a user is willing to spend retrying an operation and going on to complete their task, instead of abandoning it due to the error.

Error logs may be grouped by being identified as corresponding to a single user session or task. A first request may be identified as the point at which the user first attempts an action, and the final response indicates either a successful outcome or the last failed attempt prior to abandoning the task with a failed outcome. The request may be made (and subsequently retried) by the client application directly or by another server-side application as a result of the user's action. Requests and retries can be grouped based on a common feature such as a session identifier, user identifier, or authentication token present in the request headers or payload. From the grouped requests, the total perceived error time may be determined from the user session.

The method may include receiving identification of response types from an application owner that signify successful outcomes or failed outcomes for a service in the application. The method may identify successful or failed outcomes by the presence or absence of response types.

The correlation 103 and error duration determining 104 steps may be combined or reversed depending on the processing of the error data. The output of these processes is an error duration and an indicator of success of an outcome for each the user task or session in which the error occurred.

The method may aggregate 105 the error duration and outcomes per backend service of the application for multiple users. This may be carried out by generating a graph, such as a histogram or other representation, of a proportion of successful outcomes versus error duration for each service in the application or for the application as a whole. The proportion of successful outcomes is a proportion of all outcomes that are successful. An outcome may be for a user task, for example, as identified by a common feature.

The method may evaluate 106 a recovery time from the graph and/or numerical analysis of the proportion of successful outcomes compared to the error duration for the error for each service. This may evaluate various features of the graph representation for different metrics to optimize recovery.

The method may define 107 as a recovery performance goal for the application based on the evaluation. This may determine MTTR goals. This may determine goals that maximize outcomes while minimizing effort in reducing MTTR. This may generate an MTTR goal for each service based on the evaluation.

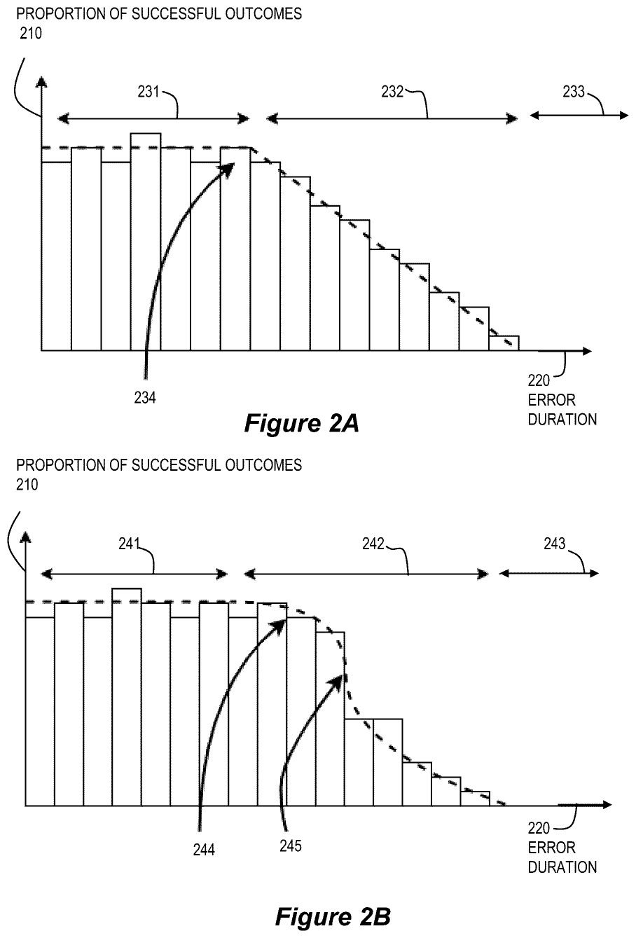

Referring to FIGS. 2A and 2B show example graphs of the proportion of successful outcomes 210 against the error duration 220 for each service in the application.

FIG. 2A shows a linear case in which in a first period 231, the error duration is in a low range, and it results in a consistent high proportion of successful outcomes. Then a second period 232 in which the increasing error duration causes a linear decline in the proportion of successful outcomes until a third period 233 in which the error duration prevents outcome success and results in a small proportion to no successful outcomes. There is an error duration time 234 identified from the graph at a point at which the second period 232 starts where the error duration starts to impact the proportion of successful outcomes. This error duration time 234 may be used to determine a recovery performance goal time, for example, as an MTTR goal for the service.

FIG. 2B shows a more complex case in which in a first period 241, the error duration is in a low range, and it results in a consistent high proportion of successful outcomes. Then a second period 242 in which the increasing error duration causes a non-linear decline in the proportion of successful outcomes until a third period 243 in which the error duration prevents outcome success and results in a small proportion to no successful outcomes. There is an error duration time 244 identified from the graph at a point at which the second period 242 starts where the error duration starts to impact the proportion of successful outcomes. There is also an error duration time 245 identified from the graph at a point at which the rate of change is the highest.

These identified error duration times 244, 245 may be used to determine a recovery performance goal time, for example, as an MTTR goal for the service. The goals are based on observed user response to application delays and failures.

The method may derive an MTTR goal for the service of the application. A trade-off point may be chosen between user success and the cost of implementing the MTTR. Setting MTTR goals based on user behavior allows the goals to be aligned with real business value.

The method and system may provide MTTR goal values for different services or components of the application. This means the application owner can focus their efforts on improving MTTR in areas that will directly drive revenue through increased user satisfaction.

Errors may be measured both from the user's and the gateway's perspective. These may give different results, for example, in the presence of script errors or network outages.

The method may be used in combination with deriving performance SLOs from real user behavior by additionally implementing a component to measure the user's perceived error duration and the time a user is willing to retry their activity, and then using the output to define an MTTR goal for the services comprising the application.

From this, target MTTRs for specific incidents may be derived, that balance business impact with cost of response. Insight may also be gained into bounce rates (users abandoning an action) per service. For example, a user may be willing to retry a payment over a several-minute period, but a failure to obtain product search results may be tolerated for only a few seconds.

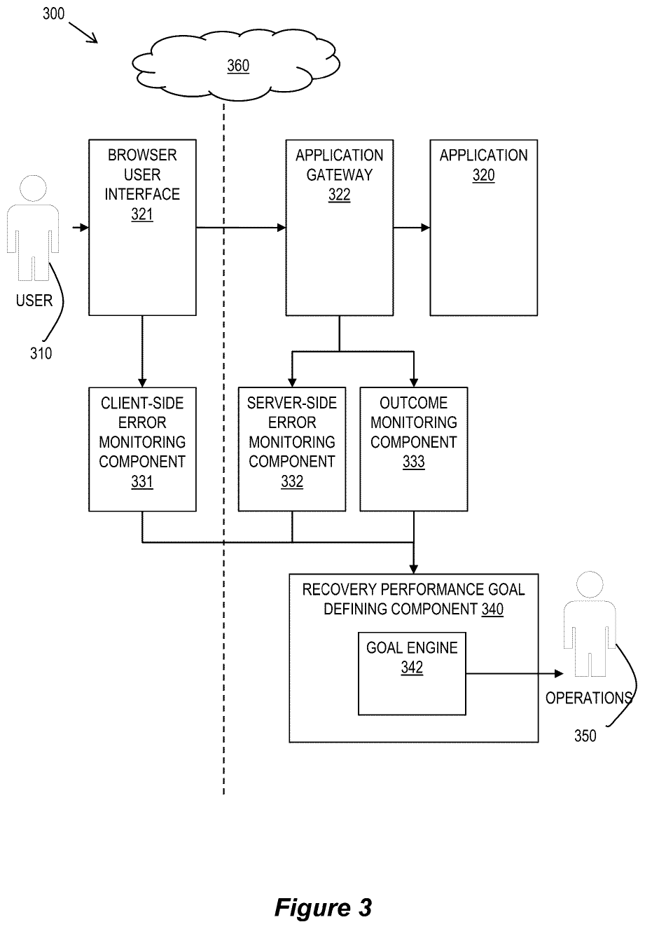

Referring to FIG. 3, a block diagram 300 shows an example embodiment of a system in which the described method may be implemented.

A user 310 may interact with a browser user interface 321 for an application 320 provided over a network 360. The application 320 may have an application gateway 322 providing access to data and functionality of backend services of the application 320.

In the described system, a client-side error monitoring component 331 may be provided. The client-side error monitoring component 331 may monitor user-perceived errors. This may include monitoring logs errors experienced by the user, such as an error response from the application gateway, a script error, or similar application failure. The described method measures the duration over which a user was willing to retry when an error is received. This may be implemented using web analytics or similar instrumentation to capture the errors and send them to a remote logging service.

A server-side error monitoring component 332 may be provided that monitors application errors. This component may monitor requests and responses at the application gateway 322 and may log the requests that are unsuccessful along with the nature of the error. This may be implemented by forwarding application gateway logs to a logging service or store.

A server-side outcome monitoring component 333 may log the successful outcomes of requests. This may log all successful requests or be configured with a filter to log only requests that represent the successful completion of a user activity. For example, successful outcomes may be reporting to a user that their purchase is complete, completing a login flow, or returning search results. An example of a response that could be filtered out may be returning a list of available payment methods. An alternative implementation may consider all the actions that lead to the final outcome (e.g. finding an item, adding it to the basket, and completing a payment).

The application owner may identify the responses that signify successful outcomes for the components of their application.

A recovery performance goal defining component 340 may be provided for processing the monitored data from the client-side error monitoring component 331, the server-side error monitoring component 332, and the outcomes monitoring component 333. The processing may be as described in relation to FIG. 1 and may include correlating and aggregating task requests as described further below.

The recovery performance goal-defining component 340 may provide a goal engine 342 for defining goals for recovery performance of the services in the application 320.

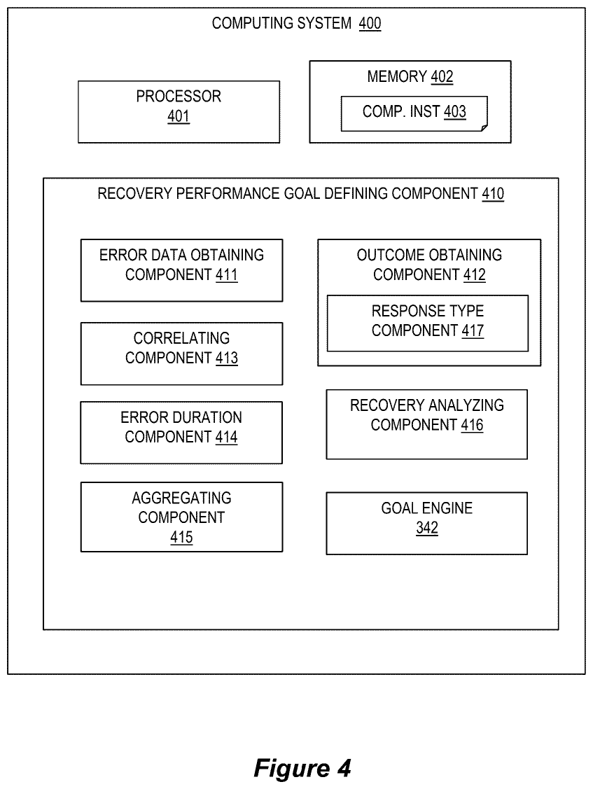

Referring to FIG. 4, a block diagram shows a computing system 400 in which the described system may be implemented. The computing system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

A recovery performance goal defining component 410 is implemented in the computing system 400 and includes: an error data obtaining component 411 for obtaining data of errors experienced by users of the application when carrying out an operation in a task; and an outcome data obtaining component 412 for obtaining data of outcomes of the task.

The error data obtaining component 411 may obtain error data as monitored by a client-side error monitoring component 331 (as shown in FIG. 3) and/or a server-side error monitoring component 332 (as shown in FIG. 3). The outcome data obtaining component 412 may obtain outcome data from an outcome monitoring component 333 (as shown in FIG. 3). Monitoring data of errors at a client-side user interface may include filtering to log requests that represent a successful outcome of a task. Monitoring data of errors at a server-side at an application gateway may log and identify requests and responses corresponding to a single user session including a starting error and a resolving response. The monitoring may capture error data and send the error data to a remote logging service.

The outcome obtaining component 412 may include a response type component 417 for receiving identification of response types that signify successful outcomes or failed outcomes for a service in the application. The identification of response types may be provided by the application owner to enable accurate identification of successful outcome indications to aid with the correlating and the error duration determining steps. Successful or failed outcomes may be identified by the presence or absence of response types.

The recovery performance goal defining component 410 may include a correlating component 413 for correlating requests and responses from the error data with an outcome of the task. Correlating requests and responses with an outcome may include identifying a starting error and a success response as achieving a successful outcome.

The recovery performance goal defining component 410 may include an error duration component 414 for determining an error duration from the requests and responses of the error data. Determining an error duration from the requests and responses of the error data includes grouping requests and responses based on a common feature to identify a user task or user session, such as a session identifier, user identifier, or authentication token.

The recovery performance goal defining component 410 may include an aggregating component 415 for aggregating the error duration and outcome per backend service of the application for multiple users.

The recovery performance goal defining component 410 may include a recovery analyzing component 416 for evaluating a recovery period based on a proportion of successful outcomes compared to an error duration for the service. Evaluating a recovery period based on a proportion of successful outcomes compared to an error duration for the service may include representing the proportion of successful outcomes against error duration in a graph and evaluating impacts of error duration on the proportion of successful outcomes. Evaluating impacts of error duration on the proportion of successful outcomes may include identifying an error duration at which the error duration negatively impacts the outcome.

The recovery performance goal defining component 410 may include a goal engine 342 for defining a recovery performance goal based on the evaluation.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

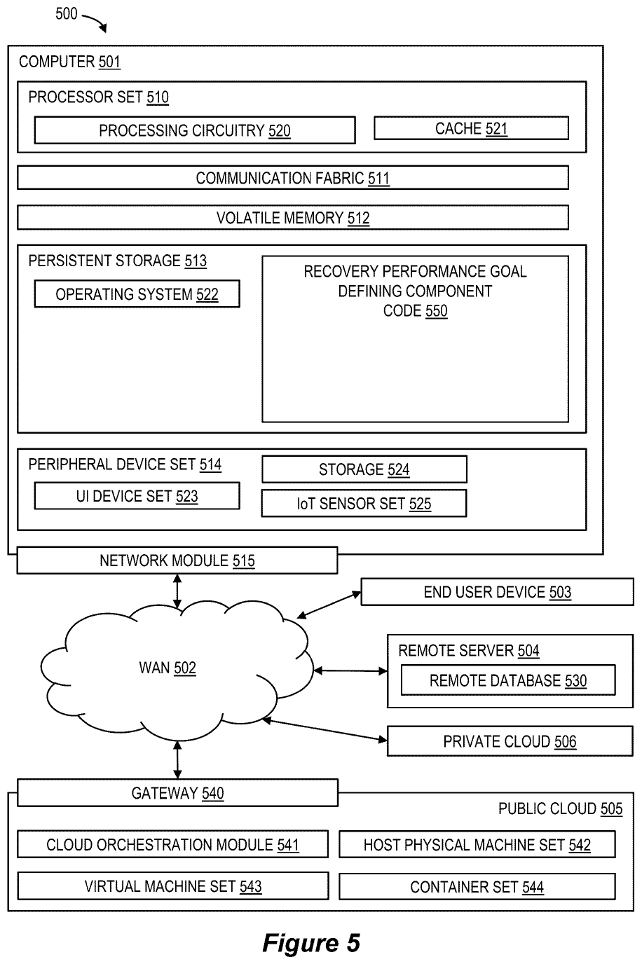

Referring to FIG. 5, computing environment 500 contains an example of an environment for the execution of at least some of the computer code involved in performing the inventive methods, such as recovery performance goal defining component code 550. In addition to block 550, computing environment 500 includes, for example, computer 501, wide area network (WAN) 502, end-user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IOT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network, or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off-chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read-only memory (ROM), but typically at least a portion of the persistent storage allows writing of data, deletion of data, and re-writing of data. Some familiar forms of persistent storage include magnetic disks and solid-state storage devices. Operating system 522 may take several forms, such as various known proprietary operating systems or open-source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer, and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs, and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for defining a recovery performance goal for an application, the method comprising:
obtaining data of errors experienced by users of the application when carrying out an operation in a task;
obtaining data of outcomes of the task;
correlating requests and responses from the error data with an outcome of the task;
determining an error duration from the requests and responses of the error data;
aggregating the error duration and outcome per backend service of the application for multiple users;
evaluating a recovery period based on a proportion of successful outcomes compared to an error duration for the service; and
defining a recovery performance goal based on the evaluation.

2. The method of claim 1, wherein correlating requests and responses with an outcome includes identifying a starting error and a success response as achieving a successful outcome.

3. The method of claim 1, including receiving identification of response types that signify successful outcomes or failed outcomes for a service in the application.

4. The method of claim 1, wherein determining an error duration from the requests and responses of the error data includes grouping requests and responses based on a common feature to identify a user task.

5. The method of claim 1, including identifying a successful outcome by a presence of subsequent requests in a same user session indicating a continuance of a user's journey.

6. The method of claim 1, wherein evaluating a recovery period based on a proportion of successful outcomes compared to an error duration for the service includes representing the proportion of successful outcomes against error duration in a graph and evaluating impacts of error duration on the proportion of successful outcomes.

7. The method of claim 1, wherein evaluating impacts of error duration on the proportion of successful outcomes includes identifying an error duration at which the error duration negatively impacts an outcome.

8. The method of claim 1, including monitoring data of errors at a client-side user interface including filtering to log requests that represent a successful outcome of a task.

9. The method of claim 1, including monitoring data of errors at a server-side at an application gateway to log and identify requests and responses corresponding to a single user session including a starting error and a resolving response.

10. The method of claim 1, wherein the recovery performance goal is a Mean Time to Recovery goal for a service of the application.

11. A system for defining a recovery performance goal for an application, comprising:
a processor and a memory configured to provide computer program instructions to the processor to execute a method of:
obtaining data of errors experienced by users of the application when carrying out an operation in a task;
obtaining data of outcomes of the task;
correlating requests and responses from the error data with an outcome of the task;
determining an error duration from the requests and responses of the error data;
aggregating the error duration and outcome per backend service of the application for multiple users;
evaluating a recovery period based on a proportion of successful outcomes compared to an error duration for the service; and
defining a recovery performance goal based on the evaluation.

12. The system of claim 11, wherein correlating requests and responses with an outcome includes identifying a starting error and a success response as achieving a successful outcome.

13. The system of claim 11, wherein the method includes receiving identification of response types that signify successful or failed outcomes for a service in the application.

14. The system of claim 11, wherein the method includes identifying successful or failed outcomes by a presence or absence of response types.

15. The system of any of claim 11, wherein determining an error duration from the requests and responses of the error data includes grouping requests and responses based on a common feature to identify a user task.

16. The system of claim 11, including identifying a successful outcome by a presence of subsequent requests in a same user session indicating a continuance of a user's journey.

17. The system of claim 11, wherein evaluating a recovery period based on a proportion of successful outcomes compared to an error duration for the service includes representing the proportion of successful outcomes against error duration in a graph and evaluating impacts of error duration on the proportion of successful outcomes, and identifying an error duration at which the error duration negatively impacts an outcome.

18. The system of claim 11, wherein the method includes monitoring data of errors at a client-side user interface including filtering to log requests that represent a successful outcome of a task.

19. The system of claim 11, wherein the method includes monitoring data of errors at a server-side at an application gateway to log and identify requests and responses corresponding to a single user session including a starting error and a resolving response.

20. A computer program stored on a computer-readable medium and loadable into internal memory of a digital computer, comprising software code portions, when the program is run on a computer, for performing a method, the method comprising:
obtaining data of errors experienced by users of an application when carrying out an operation in a task;
obtaining data of outcomes of the task;
correlating requests and responses from the error data with an outcome of the task;
determining an error duration from the requests and responses of the error data;
aggregating the error duration and outcome per backend service of the application for multiple users;
evaluating a recovery period based on a proportion of successful outcomes compared to an error duration for the service; and
defining a recovery performance goal based on the evaluation.
